(19) United States
(12) Patent Application Publication
(10) Pub. No.: US 2021/0089919 A1
(43) Pub. Date: Mar. 25, 2021

(54) ADJUSTING A PRUNED NEURAL NETWORK

(71) Applicant: DSP Group Ltd., Herzliya (IL)

(72) Inventor: TOMER MALACH, Ramat Gan (IL)

(73) Assignee: DSP Group Ltd., Herzliya (IL)

(21) Appl. No.: 17/003,967

(22) Filed: Aug. 26, 2020

Related U.S. Application Data
(60) Provisional application No. 62/902,406, filed on Sep. 19, 2019.

(51) Int. Cl. G06N 3/08; G06N 3/04

(52) U.S. Cl. CPC G06N 3/082; G06N 3/04

(57) ABSTRACT

A method for adjusting a pruned neural network, the method may include adjusting weights of the pruned neural network to provide an adjusted neural network. The pruned neural network was generated by a pruning process and is associated with pruning related weights. The pruning related weights include survived weights and erased weights. A survived weight was assigned a non-zero value by the pruning process. An erased weight was assigned a zero value by the pruning process. The adjusting may include setting values of some of the adjusted weights based on values of at least one of the pruning related weights.

### CROSS REFERENCE

This application claims priority from U.S. provisional patent No. 62/902,406 filing date Sep. 19, 2019, which is incorporated herein by reference.

### BACKGROUND

Neural network may include a very large number of weights.

Neural network processing operations that are related to large neural network are power consuming, bandwidth consuming and computational resources consuming.

Weights can be compressed by pruning. Pruning includes zeroing weights that are below a threshold.

The pruning may reduce the accuracy of the neural network in manners that are hard to predict.

In order to evaluate the affect of pruning and to adjust a pruned neural network (for compensate for inaccuracies introduced by the pruning), the pruned neural network is evaluated and its weights are recalculated by performing a retraining process. Retraining is lengthy and requires substantial amounts of resources.

There is a growing need to adjust a pruned neural network in an efficient manner—especially without the need of retraining.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a an adjustment of kernel of a neural network that has nine coefficients;

FIG. 2 illustrates an example of a performance of an adjustment of a pruned neural network;

FIG. 3 illustrates examples of various neural networks; and

FIG. 4 illustrates an example of a method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Any reference in the specification to a system should be applied mutatis mutandis to a method that can be executed by the system.

Because the illustrated at least one embodiment of the present invention may for the most part, be implemented using instructions executed by electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

The terms “weight” and “neural network coefficient” are applied in an interchangeable manner.

There may be provide a method and a computer readable medium for adjusting a pruned neural network. The method may reduce the need and even eliminate the need to retain the neural network after the adjustment.

A pruned neural network includes non-zero weights that “survived” the pruning. These weights are referred to as survived weights.

Weights that were zeroed during the pruning are referred to as erased weights.

It has been found that a pruned neural network may be adjusted by amending the survived weights based on the values of the survived weights and the values of the erased weights.

Negative valued survived weights of a layer of the neural network may be amended based on values of (i) negative valued erased weights of the layer, and (ii) negative valued survived weights of the layer.

The pruned neural network may be adjusted to provide an adjusted neural network. The adjusted neural network may include adjusted weights. During the adjustment a weight of the pruned neural network may be replaced by an adjusted weight. The adjusted neural network may be re-adjusted using the same process.

The replacement of the pruner weight and/or the calculating of the value of an adjusted weight may also be referred to as assigning a new value to the adjusted weight.

A layer is a non-limiting example of a group. A layer may be a line, a two dimensional array of weights. The layer may also be a higher dimensional array of coefficients.

A new value of a negative valued survived weight of a layer may be a function of (a) the current value of the negative valued survived weights, (b) a sum of all negative valued survived weight of the layer, and (c) a sum of all negative valued erased weights of the layer.

A new value of a negative valued survived weight of a layer may equal (a) the current value of the negative valued survived weight, multiplied by (b) a sum of all negative valued erased weight of the layer, and divided by (c) a sum of all negative valued survived weight of the layer.

A new value of a positive valued survived weight of a layer may be a function of (a) the current value of the positive valued survived weights of the layer, (b) a sum of all positive valued survived weight, and (c) a sum of all positive valued erased weight of the layer.

Positive valued survived weights of a layer may be amended based on values of (i) positive valued erased weights of the layer, and (ii) positive valued survived weights of the layer.

A new value of a positive valued survived weight of a layer may equal (a) the current value of the positive valued survived weight of the layer, multiplied by (b) a sum of all positive valued erased weight, and divided by (c) a sum of all positive valued survived weights of the layer.

It should be noted that other functions that sum and ratio may be applied.

It should be noted that a new value of a survived weight may be based on values of weights that belong to a group of weight that differ from a layer.

It should be noted that a new value of a negative valued survived weight may be based on values of only some of negative valued survived and/or erased negative valued weights.

It should be noted that a new value of a positive valued survived weight may be based on values of only some of positive valued survived and/or erased positive valued weights.

It should be noted that the same initial neural network may undergo one or more pruning and adjustment iterations in which different pruning parameters (such as thresholds) may be used. This will assist in selecting a preferred pruned neural network. It should be noted that the same pruned neural network may undergo multiple adjustment iterations with different adjustment parameters,

There may be provided a method that may include (a) pruning a neural network to provide a pruned neural network (or receiving the pruned neural network), (b) adjusting survived weights based on values of survived weight and erased weight to provide an adjusted neural network, and (c) optionally evaluating the performance of the adjusted neural network and determine whether to jumping to the step of receiving the pruned neural network and maybe adjust the pruned neural network in another manner. The determining of whether to jump may be based on the performance of the adjusted neural network or another consideration.

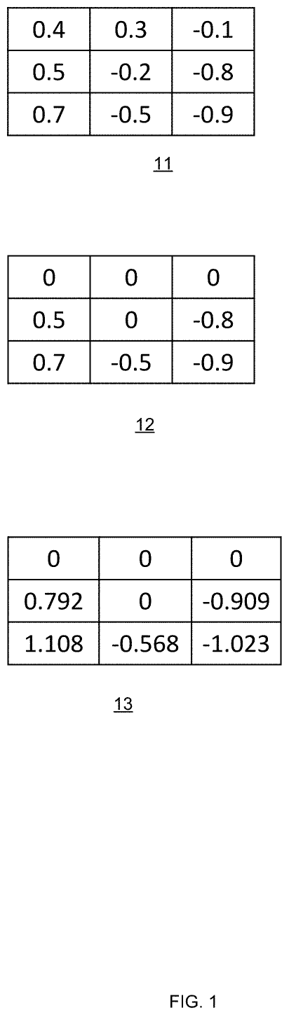

FIG. 1 illustrates an example of the equations illustrated in the two paragraphs above. FIG. 1 illustrates parts of various neural networks—initial kernel 11 of a neural network before pruning, a pruned kernel 12 of a pruned neural network and a fixed kernel 13 of an adjusted neural network. The pruning used a threshold of 0.45.

The following steps are executed when the fixed kernel is calculated:
a. Calculating a sum all the positive erased weights=0.7.
b. Calculating a sum all the negative erased weights=−0.3.
c. Calculating a sum all the positive survived weights=1.2.
d. Calculating a sum all the negative survived weights=−2.2.
e. Calculating the value of an adjusted weight associated with a positive value pruned weight (W) is: W+W×(sum of all positive erased weights/sum of all positive survived weights).
f. The value of an adjusted weight associated with a negative value pruned weight (W) is: W+W×(sum of all negative erased weights/sum of all negative survived weights).

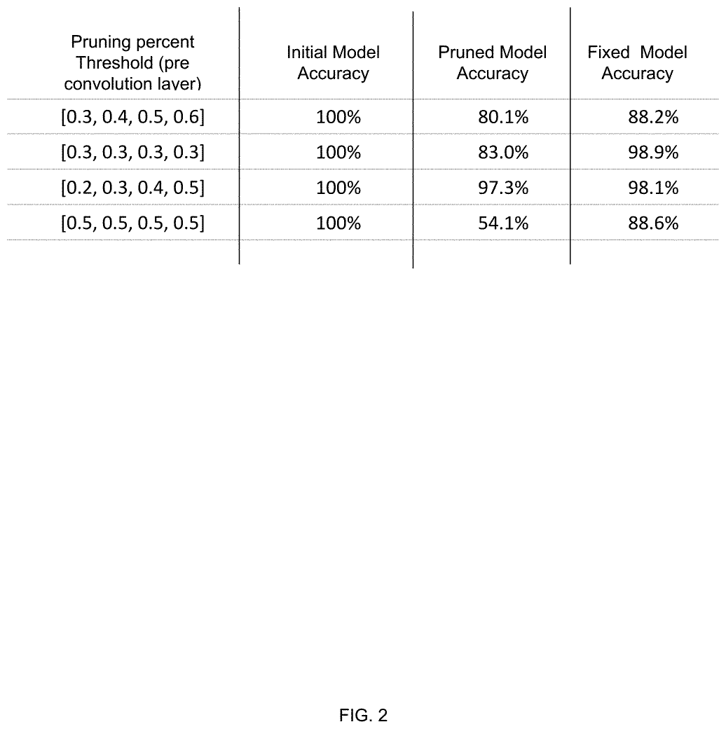

FIG. 2 illustrates includes a table that provides examples of the performance of applying the adjustment for different pruning percent thresholds.

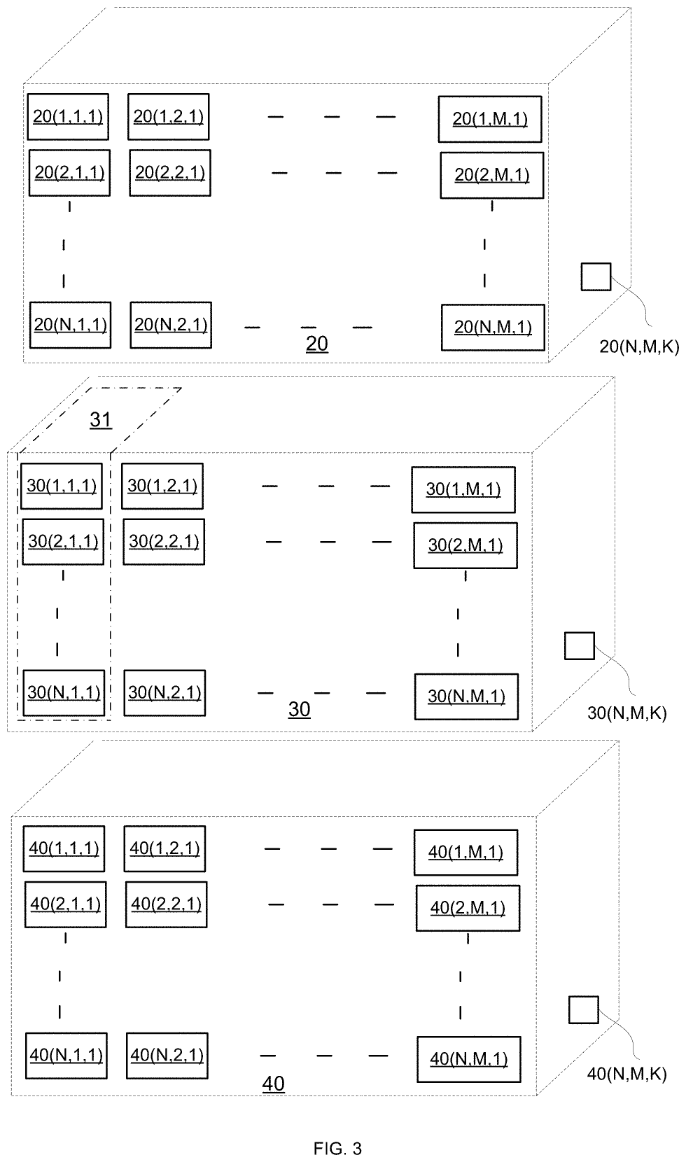

FIG. 3 illustrates an initial neural network 20, a pruned neural network 30 and an adjusted neural network 40.

N, M and K are integers that exceed two.

Each of the neural networks includes N×M×K weights—for example arranged in L different layers.

Initial neural network 20 includes initial weights 20(1,1,1)-20(N,M,K).

Pruned neural network 30 includes pruned weights 30(1,1,1)-30(N,M,K). An example of a group 31 that is a layer is shown.

Adjusted neural network 40 includes initial weights 40(1,1,1)-40(N,M,K).

It should be noted that the N×M×K weights may represent only a part (one or more layers) of the initial neural network, the pruned neural network and the adjusted neural network, respectively.

Assuming that initial weight 20(1,1,1) was not zero and that it was converted (during the pruning) to zero valued pruned weight 30(1,1,1) then initial weight 20(1,1,1) is an erased weight.

Assuming that initial weight 20(N,M,K) was converted (during the pruning) to non-zero valued pruned weight 30(N,M,K) then pruned weight 20(N,M,K) is a survived weight.

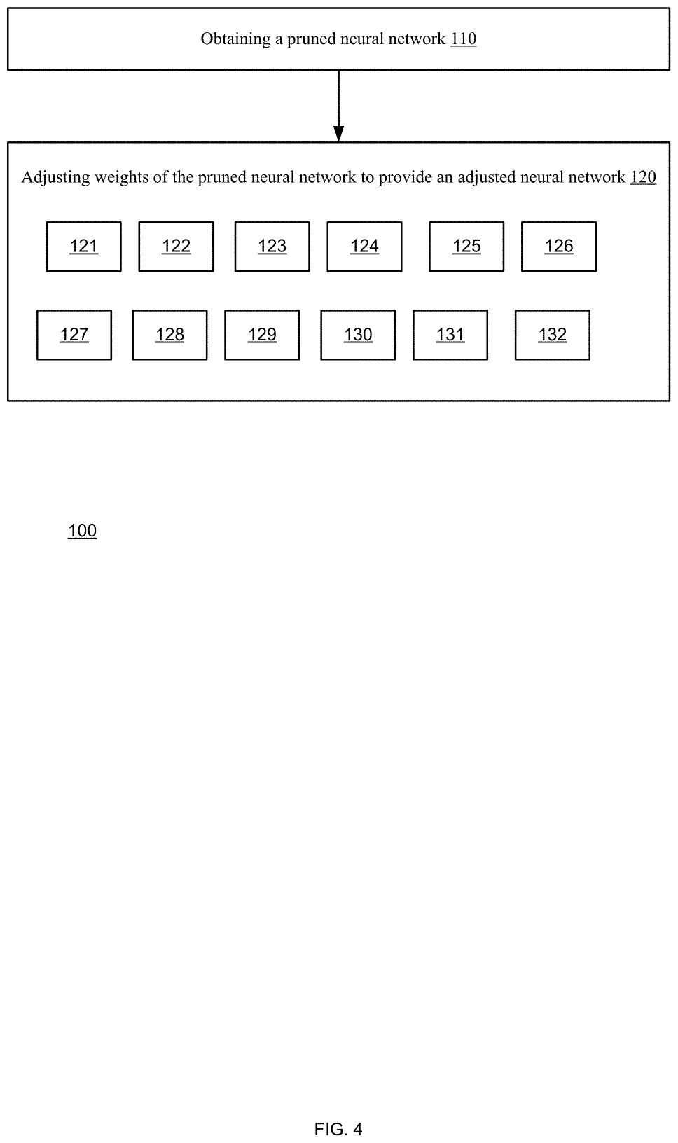

FIG. 4 illustrates a method 100 for adjusting a pruned neural network.

Method 100 may start by step 110 of obtaining a pruned neural network.

Step 100 may include receiving the pruned neural network or generating the pruned neural network.

The pruned neural network was generated by applying a pruning process on another (for example an initial—for example, an unpruned) neural network.

The pruned neural network is associated with pruning related weights. The pruning related weights include survived weights and erased weights.

A survived weights was assigned a non-zero value by the pruning process.

An erased weight is a weight of the other neural network (for example the initial neural network) that was assigned a zero value by the pruning process.

Step 110 may be followed by step 120 of adjusting weights of the pruned neural network to provide an adjusted neural network.

The adjusting includes setting values of some of the adjusted weights based on values of at least one of the pruning related weights.

Step 120 includes replacing pruned weights by adjusted weights.

Step 120 may be applied only on the survived weights.

The weights of the pruned neural network may be grouped to groups—such as layers. When replacing a weight of a certain group, step 120 may take into account only one or more weights of the certain group and/or may take into account one or more weights outside the group.

Step 120 may be executed without retraining. This saves significant amount of computational resources.

Step 120 may include at least one of steps 121-132.

Either one of steps 121-132 may be applied on one, some or all of the survived weights.

Step 121 may include calculating a value of an adjusted weight based on values of at least one survived weight, and at least one erased weight.

Step 122 may include calculating a value of an adjusted weight based on values of all survived weight, and all erased weight.

Step 123 may include calculating a value of an adjusted weight based on values of only some of the survived weights, and only some of the erased weights.

Step 124 may include calculating a value of an adjusted weight that replaces a positive value survived weight based only on one or more values of positive value pruning related weights.

Step 125 may include calculating a value of an adjusted weight that replaces a positive value survived weight based on one or more values of positive value pruning related weights and one or more values of negative value pruning related weights.

Step 126 may include calculating a value of an adjusted weight that replaces a negative value survived weight based only on one or more values of negative value pruning related weights.

Step 127 may include calculating a value of an adjusted weight that replaces a value of a weight of the pruned neural network and belongs to a group is based only on values of pruning related weights associated with the group.

Step 128 may include calculating a value of an adjusted weight that replaces a value of a weight of the pruned neural network and belongs to a group is based, at least in part, on values of pruning related weights associated with at least one other group of the groups.

Step 129 may include calculating a value of an adjusted weight that replaces a negative valued survived weight of a group is based on a current value of the negative valued survived weights, a sum of all negative valued survived weight of the group, and a sum of all negative valued erased weights of the group.

Step 130 may include calculating a value of an adjusted weight that replaces a negative valued survived weight of a group is based on a current value of the negative valued survived weights, and (a) a sum of all negative valued survived weight of the group, divided by (b) a sum of all negative valued erased weights of the group.

Step 131 may include calculating a value of an adjusted weight that replaces a positive valued survived weight of a group is based on a current value of the positive valued survived weights, a sum of all positive valued survived weight of the group, and a sum of all positive valued erased weights of the group.

Step 132 may include calculating a value of an adjusted weight that replaces a positive valued survived weight of a group is based on a current value of the positive valued survived weights, and (a) a sum of all positive valued survived weight of the group, divided by (b) a sum of all positive valued erased weights of the group.

Method 100 may be executed by a computer that may have a memory unit and a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any reference to any of the terms “comprise”, “comprises”, “comprising” “including”, “may include” and “includes” may be applied to any of the terms “consists”, “consisting”, “and consisting essentially of”.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between MEMS elements are merely illustrative and that alternative embodiments may merge MEMS elements or impose an alternate decomposition of functionality upon various MEMS elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for adjusting a pruned neural network, the method comprises: adjusting weights of the pruned neural network to provide an adjusted neural network; wherein the pruned neural network was generated by a pruning process and is associated with pruning related weights, the pruning related weights comprise survived weights, and erased weights, wherein each of the survived weights was assigned a non-zero value by the pruning process; wherein each of the erased weights was assigned a zero value by the pruning process; wherein the adjusting comprises setting values of some of the adjusted weights based on values of at least one of the pruning related weights.

2. The method according to claim 1 wherein the adjusting is executed without retraining.

3. The method according to claim 1 wherein the adjusting comprising calculating a value of an adjusted weight based on values of at least one survived weight, and at least one erased weight.

4. The method according to claim 1 wherein the adjusting comprising calculating a value of an adjusted weight based on values of all survived weight, and all erased weight.

5. The method according to claim 1 wherein the adjusting comprising calculating a value of an adjusted weight based on values of only some of the survived weights, and only some of the erased weights.

6. The method according to claim 1 wherein the adjusting comprising calculating a value of an adjusted weight that replaces a positive value survived weight based only on one or more values of positive value pruning related weights.

7. The method according to claim 1 wherein the adjusting comprising calculating a value of an adjusted weight that replaces a positive value survived weight based on one or more values of positive value pruning related weights and one or more values of negative value pruning related weights.

8. The method according to claim 1 wherein the adjusting comprising calculating a value of an adjusted weight that replaces a negative value survived weight based only on one or more values of negative value pruning related weights.

9. The method according to claim 1 wherein the weights of the pruned neural network are arranged in groups, wherein the adjusting comprising calculating a value of an adjusted weight that replaces a value of a weight of the pruned neural network and belongs to a group of the groups is based only on values of pruning related weights associated with the group.

10. The method according to claim 1 wherein the weights of the pruned neural network are arranged in groups, wherein the adjusting comprising calculating a value of an adjusted weight that replaces a value of a weight of the pruned neural network and belongs to a group of the groups is based, at least in part, on values of pruning related weights associated with at least one other group of the groups.

11. The method according to claim 1 wherein the weights of the pruned neural network are arranged in groups, wherein the adjusting comprising calculating a value of an adjusted weight that replaces a negative valued survived weight of a group is based on a current value of the negative valued survived weights, a sum of all negative valued survived weight of the group, and a sum of all negative valued erased weights of the group.

12. The method according to claim 1 wherein the weights of the pruned neural network are arranged in groups, wherein the adjusting comprising calculating a value of an adjusted weight that replaces a negative valued survived weight of a group is based on a current value of the negative valued survived weights, and (a) a sum of all negative valued survived weight of the group, divided by (b) a sum of all negative valued erased weights of the group.

13. The method according to claim 1 wherein the weights of the pruned neural network are arranged in groups, wherein the adjusting comprising calculating a value of an adjusted weight that replaces a positive valued survived weight of a group is based on a current value of the positive valued survived weights, a sum of all positive valued survived weight of the group, and a sum of all positive valued erased weights of the group.

14. The method according to claim 1 wherein the weights of the pruned neural network are arranged in groups, wherein the adjusting comprising calculating a value of an adjusted weight that replaces a positive valued survived weight of a group is based on a current value of the positive valued survived weights, and (a) a sum of all positive valued survived weight of the group, divided by (b) a sum of all positive valued erased weights of the group.

15. The method according to claim 1 comprising re-adjusting the adjusted neural network.

16. A non-transitory computer readable medium that stores instructions for: adjusting weights of a pruned neural network to provide an adjusted neural network; wherein the pruned neural network was generated by a pruning process and is associated with pruning related weights, the pruning related weights comprise survived weights, and erased weights, wherein each of the survived weights was assigned a non-zero value by the pruning process; wherein each of the erased weights was assigned a zero value by the pruning process; wherein the adjusting comprises setting values of some of the adjusted weights based on values of at least one of the pruning related weights.
